(19) United States
(12) Patent Application Publication
(10) Pub. No.: US 2007/0152958 A1
(43) Pub. Date: Jul. 5, 2007

(54) Button-type device for three dimensional rotation and translation control

(75) Inventors: Jaewoo Ahn, Kyeonggi province (KR); Seungeun Lee, Kyungsangbuk-do (KR)

Correspondence Address: JHK LAW, P.O. BOX 1078, LA CANADA, CA, 91012-1078, US

(73) Assignee: MOBIENCE, INC., Seongnam City (KR)

(21) Appl. No.: 10/596,540

(22) PCT Filed: Dec. 16, 2004
(86) PCT No.: PCT/KR04/03317

§ 371 Date: Jun. 15, 2006

(30) Foreign Application Priority Data
Dec. 16, 2003 (KR) 10-2003-0091987

(51) Int. Cl. G09G 5/00

(52) U.S. Cl. 345/156

(57) ABSTRACT

Disclosed herein is a device for rotating or translating a three-dimensional object using a 3×3 button array, in which an application program runs to rotate and to translate a predetermined three-dimensional object on a display screen. The device comprises a button-part including 9 buttons of a 3×3 array and having combinations of buttons on horizontal, vertical, and diagonal lines, corresponding to the direction of rotation or translation of a three-dimensional object on the three-dimensional axis of rotation or along the axis of translation; and a microcomputer for recognizing the depression combination of buttons, the order of the button depressed, and the key-depressing time and outputting a control signal so as to rotate or to translate a portion of or whole configuration of the three-dimensional object on the display screen. Without using a pointing method through an additional device like a mouse, the direction of rotation, the angle of rotation, and the direction of translation can be assigned, furthermore partial/whole rotation on the more than three axes and translation are easily controlled, so that a program controlling the rotation and the translation of a three-dimensional object can be applied to any device which has a 3×3 button array, thereby enhancing the applicability.

### TECHNICAL FIELD

The present invention relates to a button-type device for three dimensional rotation or translation control, in particular to such a device, in which an application program which rotates and translates a predetermined three dimensional object on a display screen is running and combinations of buttons on horizontal/vertical/diagonal lines are configured from a 3×3 button array so as to control the rotation and the translation of a three dimensional object on each axis.

### BACKGROUND ART

Referring to a block diagram of a device for three-dimensional rotation and translation control, which is depicted in FIG. 1, a button-type device for three-dimensional rotation or translation control in a conventional invention is hereafter explained.

A certain program, one of application programs which run on a device such as a computer, has a function of rotating a three dimensional object in a clockwise or a counterclockwise direction on a predetermined axis or translating along a predetermined axis. In order to execute such an application program, basically a computing device, which is equipped with a microcomputer, and a pointing and dragging input device, which is connected to the computing device to rotate and to translate the three dimensional object, are required. Generally a mouse 10 is used for that purpose.

That is, as shown in FIG. 1, a conventional device for three-dimensional rotation and translation control comprises a computing main device including a microcomputer 20 for executing an application program, a display device (an output device) 30 for displaying the process of execution of the application program, and a mouse 10 for inputting a control command of a user to rotate and to translate a three dimensional object.

In addition, a small device such as a telephone, a cellular phone, a PDA, and a calculator comprises a microcomputer which have the rotation and the translation of a three dimensional object displayed on a screen according to the manipulation, an input device (not shown) which comprises multiple buttons, and a display device (not shown) which displays numeric data and so on.

Nevertheless, in case of a conventional application program rotating and translating a three-dimensional object, operation of rotation and translation is manipulated by a mouse 10, so that a small device which cannot connect a mouse has a problem in that it cannot use such an application program.

Here, a typical example of an application program rotating and translating a three-dimensional object is the Rubik's Cube, a game program assembling each side of a cube with squares of the same color by rotating the cube. The Rubik's Cube game, developed by Errno Rubik, a Hungarian professor of construction engineering, in 1973, won wide popularity with the world as well as Korea, and besides manipulating the real cube with hands, in reality, many people play the Cube game on computers executing as a computer game program.

Each side of a cube has a different color. A cube is composed of 3×3×3 unit cubes in many cases, and complexity of the game increases as the number of unit cube increases. The game is over when all the corresponding surfaces of the nine unit cubes, which composes one surface of the whole cube, have the same color by rotating one or two columns of the three columns which compose each surface (nine unit cubes in total compose one column).

The Rubik's Cube is a game that can improve the ability of mathematical spatial perception, in a conventional way, however, the frequency of use in a small device (especially in a mobile device) like a computer or a notebook computer, which is connected with a mouse 10, was remarkably low, and especially rotation and translation was enabled only by an input device such as a mouse or a touch pad, which is easy to point and to move a pointer, thereby it was restricted to be developed as a game module embedded into a small device. In addition, precise positioning and delicate controlling are required when using these input devices, and therefore the manipulation becomes slow and a user needs to pay much attention even when doing a simple operation.

### DISCLOSURE OF INVENTION

The present invention has been made in order to solve the above problems occurring in the prior art, and it is an object of the invention to provide a button-type device for three-dimensional rotation or translation control, in which an application program, which has a function of rotating and translating a three-dimensional object and is executed in a device equipped with a button-part of a 3×3 array, can select the direction of rotation, the angle of rotation, and the axis of rotation merely by handling buttons, and simplifies the method of rotation and translation to enable the translation along a predetermined axis. Combinations of buttons, corresponding to the axis of rotation and the direction of translation, are provided from the button-part of a 3×3 array on the horizontal, vertical, and diagonal lines, making it possible to learn the method of operation easily, so that types of device, to which an application program that controls the rotation and the translation of a three-dimensional object is applied, can be diversified.

In order to accomplish the above object, according to the one aspect of the invention, there is provided a button-type device for three-dimensional rotation or translation control, in which an application program runs to rotate and to translate a predetermined three-dimensional object on a display screen. The button-type device comprises: a button-part including 9 buttons of a 3×3 array and having combinations of buttons on horizontal, vertical, and diagonal lines, corresponding to the direction of rotation or translation of a three-dimensional object on the three-dimensional axis of rotation or along the axis of translation; and a microcomputer for recognizing the depression combination of buttons, the order of the button depressed, and the key-depressing time and outputting a control signal so as to rotate or to translate a portion of or whole configuration of the three-dimensional object on the display screen.

A button-type device, configured as above, for three-dimensional rotation or translation control in accordance with the present invention has several effects as follows: The manipulation of buttons in a button-part of a 3×3 array becomes simple and convenient by providing combinations of buttons on the horizontal, vertical, and diagonal lines, which correspond to the direction of axis of rotation and the direction of rotation. The direction of rotation, the angle of rotation, and the center axis of rotation can be selected to rotate the three-dimensional object. The axis of translation can be selected, enabling the unit translation and the continuous translation of the three-dimensional object along the axis of translation. Type of device, to which an application program that controls the rotation and the translation of a three-dimensional object is applied, can be diversified

### BRIEF DESCRIPTION OF DRAWINGS

Further objects and advantages of the invention can be more fully understood from the following detailed description taken in conjunction with the accompanying drawings, in which:

FIG. 1 is a block diagram of a device for three-dimensional rotation and translation control according to a conventional invention;

FIG. 2 is a perspective view showing a three-dimensional object, its axis of rotation, its direction of rotation, and its axis of translation;

FIGS. 3 to 8 are perspective views showing three-dimensional objects rotated according to various axes of rotation, directions of rotation, and unit angles of rotation;

FIG. 9 is a block diagram showing a button-part of a device for three-dimensional rotation and translation control; and

FIGS. 10 to 12 are perspective views showing three-dimensional objects partially rotating using a button-part according to the present invention.

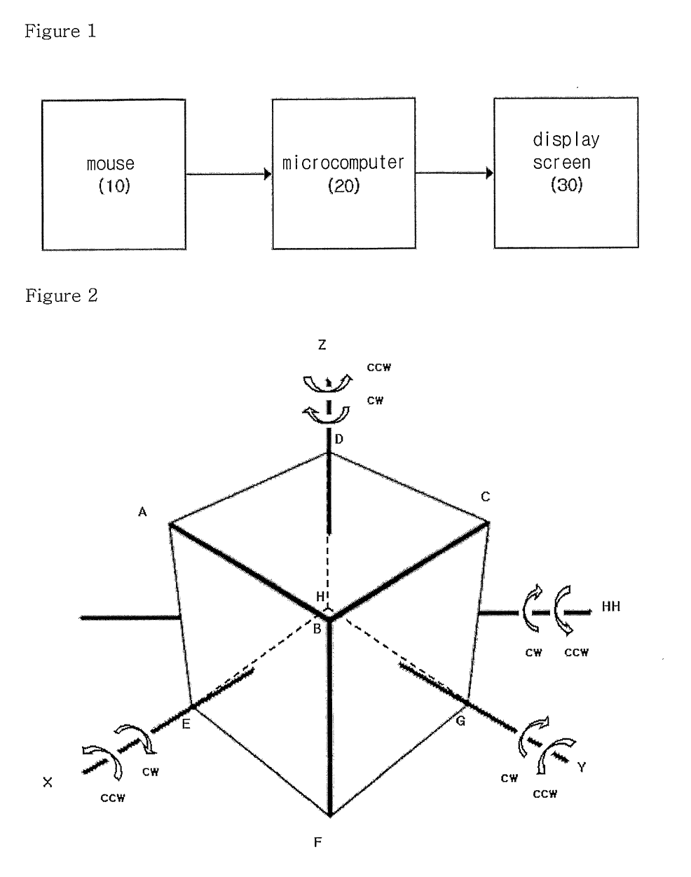

### BEST MODE FOR INVENTION

Hereafter, the preferred embodiments of the present invention will be explained with reference to the accompanying drawings. A solid cube is an example of a three-dimensional object, and the number of array is not restricted by the present specifications.

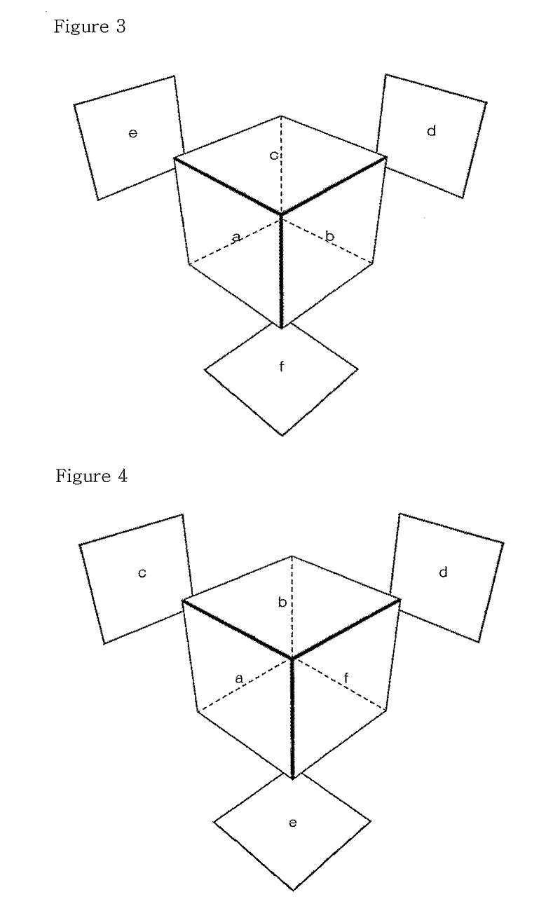

First, referring to FIG. 2, the possible axes of rotation of a solid cube, as depicted, comprises the X, the Y, and the Z axis each connecting the opposite side respectively, the HH axis which exists on the same plane of the X and the Y axis at an angle of 45 degrees from the −X and the Y axis (the horizontal direction from the viewpoint), and 4 diagonal axes linking the vertex of each regular square, which composes a unit surface of a solid cube, to the vertex of the opposite side through the centroid (the center of mass).

The above diagonal axes comprise the AG axis which links vertex A and G (the first diagonal axis), the CE axis which links vertex C and E (the second diagonal axis), the DF axis which links vertex D and F (the third diagonal axis), and the BH axis which links vertex B and H (the forth diagonal axis), and in case the HH axis is the center axis, if the cube rotates in 180 degrees forward or backward, the upper and the lower sides are exchanged and the rear side faces forward.

The solid cube rotates by a unit angle of rotation of 60-, 90-, 120-, 180-degree arcs on the above eight axes, and in some cases, a user can select the unit angle of rotation. The direction of rotation can be specified as clockwise or counterclockwise on each axis respectively.

FIG. 3 depicts an embodiment showing the rotated state of a cube in each case of different unit angles of rotation and different directions of rotation on each axis. First, FIG. 3 is a perspective view of a cube in a standby state before rotation: a and b are front sides of a cube, d and e are rear sides of a cube, and c and f are the upper and the lower side of a cube, respectively. Especially the rear sides d and e, and the lower side f, which are not shown in the figure, are depicted separately for clear understanding in the figure.

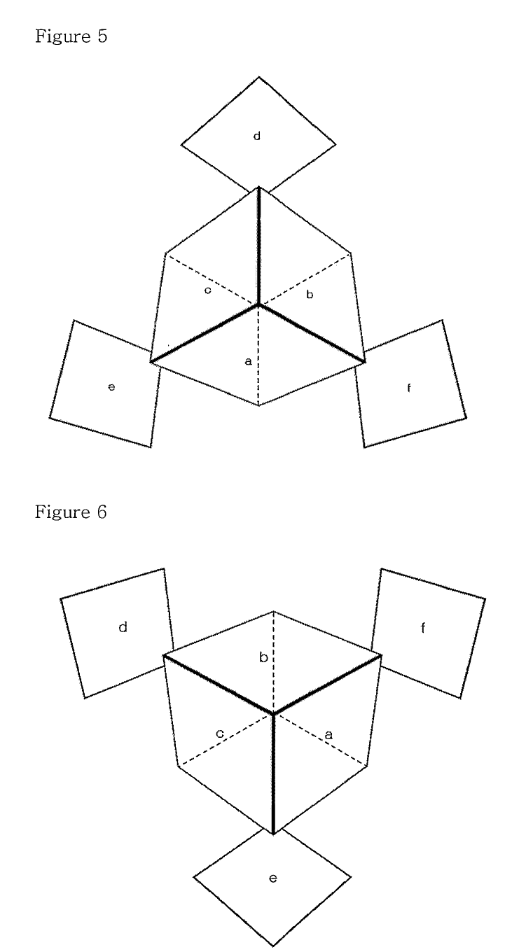

On the basis of FIG. 3, when the cube rotates in 90 degrees on the X axis in the direction of counterclockwise, it becomes as shown in FIG. 4. That is, side a and side d, where the X axis passes through, are unchanged, and the other sides rotate in the direction of counterclockwise.

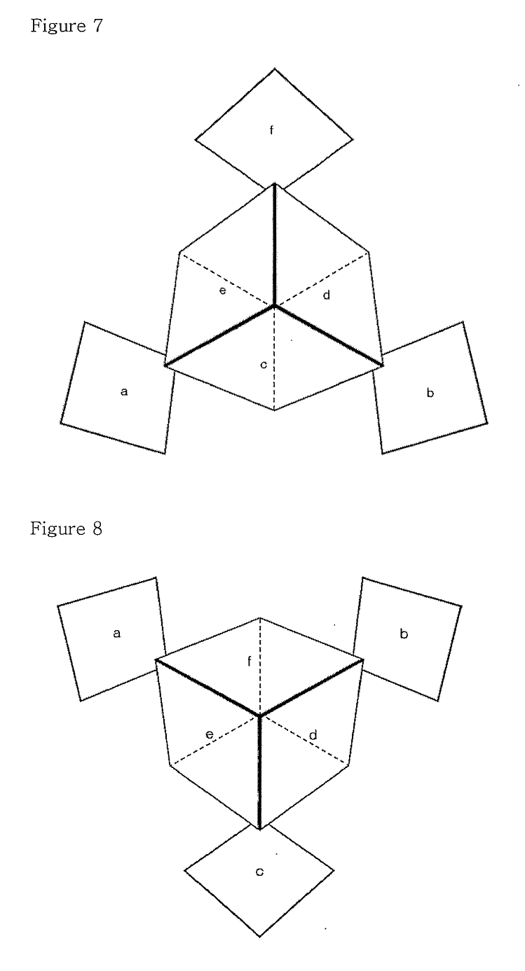

FIG. 5 shows the rotation in 60 degrees on the BH axis in the direction of counterclockwise on the basis of FIG. 3, and FIG. 6 shows the rotation in 120 degrees on the BH axis in the direction of counterclockwise on the basis of FIG. 3.

FIG. 7 shows the rotation in 90 degrees on the HH axis in the direction of counterclockwise (backward) on the basis of FIG. 3, and FIG. 8 shows the rotation in 180 degrees on the HH axis in the direction of counterclockwise (backward) from the base position of FIG. 3. That is, the front and the rear are inverted in 180 degrees, and even when it rotates in 180 degrees in the direction of clockwise (forward), it show the same cube state.

Each axis depicted in FIG. 2 and the cube states rotated on the axes are shown in FIG. 3. Hereafter, referring to these figures, a method of manipulating buttons to rotate the cube on each axis is explained.

A button-part 100 depicted in FIG. 10 is the general terms for buttons which are included in a small device, a computer keyboard, and all the other compact devices such as a cellular phone, a PDA, a calculator, and a phone. Regardless of the type of button, i.e. numeric buttons, character buttons, special character buttons, etc., buttons are arranged in a 3×3 array basically.

For clear understanding, a button-part 100 comprising numeric keys 1 to 9 is exemplified in the specifications, however, according to the arrangement of the keys, sequential numbers or rows can be arranged from the top to the bottom, from the bottom to the top, from the left to the right, or from the right to the left. In the specifications, the present invention will be explained below with an embodiment in which buttons 1 to 9 are arranged from the top to the bottom. Needless to say, depending on a device comprising numeric buttons, a numeric button 0 and special character buttons of * and # can be added to the numeric buttons 1 to 9.

For the button-part 100, the first embodiment includes combinations of buttons on horizontal, vertical, and diagonal lines corresponding to the direction of rotation of a three-dimensional object on the three-dimensional axis of rotation, and the second embodiment includes combinations of buttons on horizontal, vertical, and diagonal lines corresponding to the at least three directions of axes of rotation which are the center of rotation of a three-dimensional object.

The microcomputer 200 connected with the button-part 100 outputs a control signal to rotate a portion of or whole configuration of a cube on the display recognizing the depression combination of buttons, the order of the button depressed, and the time of depressing a key, and since the unit angle of rotation assigned by a user is stored in a memory, the microcomputer refers to the stored details of the memory (not shown).

Also, the microcomputer 200 determines the direction of rotation of the three-dimensional object, either clockwise rotation or counterclockwise rotation, according to the order of the button depressed by the button-part 100, and the angle of rotation according to the unit angle of rotation stored in the memory.

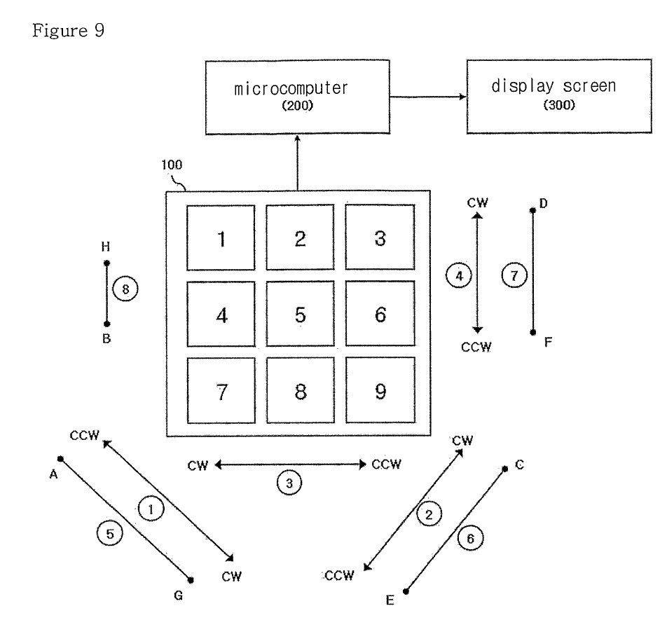

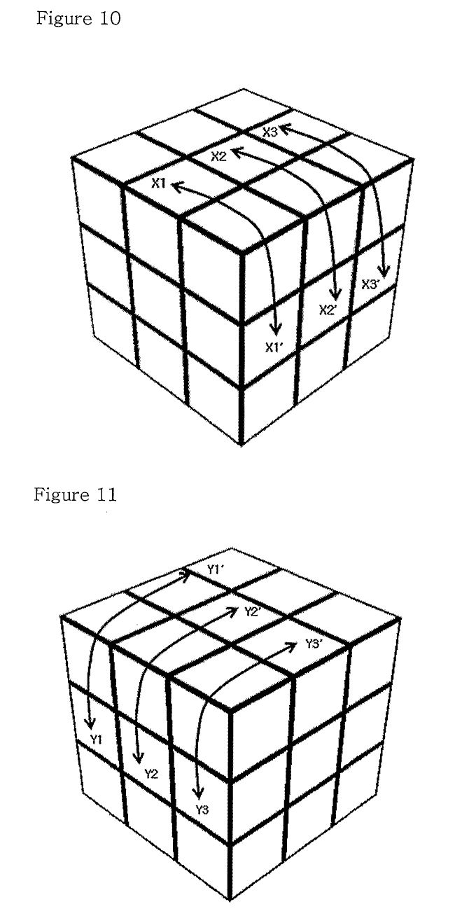

In the 3×3 arrangement of the button-part 100 shown in FIG. 9, the direction of rotation on the X, the Y, the Z, the HH axes are denoted by \textcircled{1}, \textcircled{2}, \textcircled{3}, and \textcircled{1} respectively, and the direction of the AG axis (the first diagonal axis), the CE axis (the second diagonal axis), the DF axis (the third diagonal axis), and the BH axis (the forth diagonal axis) are denoted by \textcircled{5}, \textcircled{6}, \textcircled{7}, and \textcircled{8}.

The combination of buttons 100, which makes it easy to control the direction, can be assigned to the button-part 100 by applying the direction of rotational translation or the direction of the axis of rotation of the cube, so that an example of the combination of buttons for the unit rotation of the cube is depicted as follows.

1) The X Axis

The direction of rotation of the cube on the X axis is diagonal as \textcircled{1}, and the counterclockwise direction indicates the left-top, so that the combination of 84, 51, 95, 91, and 62 can be input sequentially.

In the same way, clockwise direction indicates the right-bottom, so that the combination of 48, 15, 59, 19, and 26 is possible. Manipulating the typical combination selected by a manufacturer among the combinations, a user can rotate the cube on the X axis.

2) The Y Axis

The direction of rotation of the cube on the Y axis is diagonal as \textcircled{2}, and the counterclockwise direction indicates the left-bottom, so that the combination of 68, 35, 57, 37, and 24 can be input sequentially; and the clockwise direction indicates the right-top, so that the combination of 86, 53, 75, 73, and 42 can be input sequentially. Manipulating the typical combination selected by a manufacturer among the combinations, a user can rotate the cube on the Y axis.

3) The Z Axis

The direction of rotation of the cube on the Z axis is horizontal as \textcircled{3}, and the counterclockwise direction indicates the right, so that the combination of 12, 23, 13, 45, 56, 46, 78, 89, and 79 is possible; and the clockwise direction indicates the left, so that the combination of 32, 21, 31, 65, 54, 64, 98, 87, and 97 is possible. Manipulating the typical combination selected by a manufacturer among the combinations, a user can rotate the cube on the Z axis.

4) The HH Axis

The direction of rotation of the cube on the HH axis is vertical as \textcircled{4}, and the counterclockwise direction (backward direction) indicates the bottom, so that the combination of 14, 47, 17, 25, 58, 28, 36, 69, and 39 is possible; and the clockwise direction (forward direction) indicates the top, so that the combination of 74, 41, 71, 85, 52, 82, 96, 63, and 93 is possible. Manipulating the typical combination selected by a manufacturer among the combinations, a user can rotate the cube on the HH axis.

5) The AG Axis (the First Diagonal Axis)

The direction of the AG axis is a slanted and crossed direction of the Y axis, corresponding to the right-bottom diagonal direction of the button-part 100. That is, the direction of the AG axis is similar to the diagonal direction comprising 1, 5, and 9 buttons, so that the AG axis can be assigned by a combination of these buttons.

When rotating the cube in the direction of counterclockwise on the AG axis, the button can be manipulated by depressing 11 or 9 for more than a predetermined time period.

In the same manner, when rotating the cube in the direction of clockwise on the AG axis, the button can be manipulated by depressing and holding 1 for a predetermined time period or depressing 99.

6) The CE Axis (the Second Diagonal Axis)

The direction of the CE axis is a slanted and crossed direction of the X axis, corresponding to the left-bottom diagonal direction of the button-part 100. That is, the direction of the CE axis is similar to the diagonal direction comprising 3, 5, and 7 buttons, so that the CE axis can be assigned by a combination of these buttons.

When rotating the cube in the direction of counterclockwise on the CE axis, the button can be manipulated by depressing 33 or depressing and holding 7 for a predetermined time period.

In the same manner, when rotating the cube in the direction of clockwise on the CE axis, the button can be manipulated by depressing and holding 3 for a predetermined time period or depressing 77.

7) The DF Axis (the Third Diagonal Axis)

The direction of the DF axis is a slanted and crossed direction of the Z axis, corresponding to the downward vertical direction of the button-part 100. That is, the direction of the DF axis is similar to the vertical direction comprising 2, 5, and 8 buttons, so that the DF axis can be assigned by a combination of these buttons.

When rotating the cube in the direction of counterclockwise on the DF axis, the button can be manipulated by depressing 22 or depressing and holding 8 a predetermined time period, and when rotating the cube in the direction of clockwise, the button can be manipulated by depressing and holding 2 for a predetermined time period or depressing 88.

8) The BH Axis (the Forth Diagonal Axis)

The direction of the BH axis penetrates from the front of the basis cube shown in FIG. 2, so that the button 5 in the center of the button-part 100 can be used. That is, when rotating the cube in the direction of counterclockwise on the BH axis, the button 55 is depressed, and when rotating the cube in the direction of clockwise, the button 5 is depressed and held for a predetermined time period.

Referring to the button-part 100 shown in FIG. 9, any device comprising a button-part of a 3×3 array can rotate the cube (a solid structure), which is implemented three-dimensionally, on each axis, and the pattern of the buttons which is depressed for the rotation of the cube can be recognized by inputting into the microcomputer 200 of the device, so that after rotating the cube to the corresponding direction, the cube is displayed.

The button groups which can be typically used from the combinations of the numeric numbers explained above may be categorized as either the first group or the second group. Undoubtedly, the other groups can be used by a manufacturer.

1) The first group
1-1) In case of rotating the whole cube

| | | |
|---|---|---|
| \textcircled{1} | counterclockwise direction on the X axis: | 51 |
| | clockwise direction: | 59 |
| \textcircled{2} | counterclockwise direction on the Y axis: | 57 |
| | clockwise direction: | 53 |
| \textcircled{3} | counterclockwise direction on the Z axis: | 56 |
| | clockwise direction: | 54 |
| \textcircled{4} | counterclockwise direction on the HH axis: | 58 |
| | clockwise direction: | 52 |
| \textcircled{5} | counterclockwise direction on the AG axis: | 11 or 9 (press and hold) |
| | clockwise direction: | 1 (press and hold) or 99 |
| \textcircled{6} | counterclockwise direction on the CE axis: | 33 or 7 (press and hold) |
| | clockwise direction: | 3 (press and hold) or 77 |
| \textcircled{7} | counterclockwise direction on the DF axis: | 22 or 8 (press and hold) |
| | clockwise direction: | 2 (press and hold) or 88 |
| \textcircled{8} | counterclockwise direction on the BH axis: | 55 |
| | clockwise direction: | 5 (press and hold) |

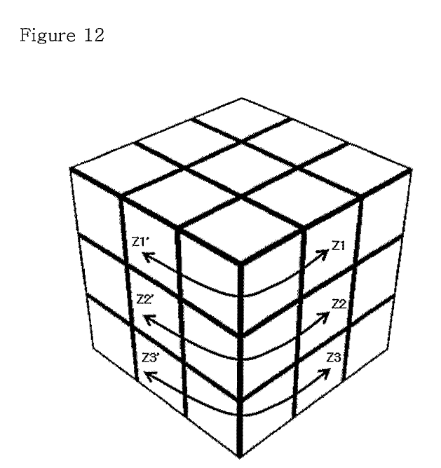

1-2) In case of partially rotating one of the columns of 3 × 3 cube

| | |
|---|---|
| counterclockwise direction on the X axis: | 84, 91, 62 (X1, X2, and X3 of FIG. 10 respectively) |
| clockwise direction: | 48, 19, 26 (X1′, X2′, and X3′ of FIG. 10 respectively) |
| counterclockwise direction on the Y axis: | 24, 37, 68 (Y1, Y2, and Y3 of FIG. 11 respectively) |
| clockwise direction: | 42, 73, 86 (Y1′, Y2′, and Y3′ of FIG. 11 respectively) |
| counterclockwise direction on the Z axis: | 13, 46, 79 (Z1, Z2, and Z3 of FIG. 12 respectively) |
| clockwise direction: | 31, 64, 97 (Z1′, Z2′, and Z3′ of FIG. 12 respectively) |

By depressing buttons of numeric combination like this, the cube can be translated to the desired direction. The rotation of the whole cube can be manipulated on each axis, and the partial translation for one column can be rotated on the axis of the X, the Y, and the Z.

2) The second group
2-1) In case of rotating the whole cube

| | | |
|---|---|---|
| \textcircled{1} | counterclockwise direction on the X axis: | 91 |
| | clockwise direction: | 19 |
| \textcircled{2} | counterclockwise direction on the Y axis: | 37 |
| | clockwise direction: | 73 |
| \textcircled{3} | counterclockwise direction on the Z axis: | 46 |
| | clockwise direction: | 64 |
| \textcircled{4} | counterclockwise direction on the HH axis: | 28 |
| | clockwise direction: | 82 |
| \textcircled{5} | counterclockwise direction on the AG axis: | 11 or 9 (press and hold) |
| | clockwise direction: | 1 (press and hold) or 99 |
| \textcircled{6} | counterclockwise direction on the CE axis: | 33 or 7 (press and hold) |
| | clockwise direction: | 3 (press and hold) or 77 |
| \textcircled{7} | counterclockwise direction on the DF axis: | 22 or 8 (press and hold) |
| | clockwise direction: | 2 (press and hold) or 88 |
| \textcircled{8} | counterclockwise direction on the BH axis: | 55 |
| | clockwise direction: | 5 (press and hold) |

2-2) In case of partially rotating one of the columns of 3 × 3 cube

| | |
|---|---|
| counterclockwise direction on the X axis: | 84, 95 or 51, 62 (X1, X2, and X3 of FIG. 10 respectively) |
| clockwise direction: | 48, 15 or 59, 26 (X1′, X2′, and X3′ of FIG. 10 respectively) |
| counterclockwise direction on the Y axis: | 24, 35 or 57, 68 (Y1, Y2, and Y3 of FIG. 11 respectively) |
| clockwise direction: | 42, 75 or 53, 86 (Y1′, Y2′, and Y3′ of FIG. 11 respectively) |
| counterclockwise direction on the Z axis: | 12 or 23, 45 or 56, 78 or 89 (Z1, Z2, and Z3 of FIG. 12 respectively) |
| clockwise direction: | 32 or 21, 65 or 54, 98 or 87 (Z1′, Z2′, and Z3′ of FIG. 12 respectively) |

By depressing buttons of numeric combination like this, the cube can be translated to the desired direction. The rotation of the whole cube can be manipulated on each axis, and the partial translation for one column can be rotated on the axis of the X, the Y, and the Z.

As described above, in the present invention, a three-dimensional object can be translated as well as rotated using buttons. That is, the microcomputer can be in a rotation mode in which a three-dimensional object is rotated on each axis or in a translation mode in which a three-dimensional object is translated in the direction of each axis, and the translation can be manipulated to the (+) and the (−) direction of the X, the Y, the Z, the HH, and the BH axes.

For example, to translate a three-dimensional object in the direction of the X axis, the button 7 and 3 are used which are positioned in the same direction as the X axis. That is, if the button 7 is input, the three-dimensional object is translated in the direction of the +X axis, while, if the button 3 is depressed, the three-dimensional object is translated in the direction of the −X axis.

In the same manner, to translate a three-dimensional object in the direction of the Y axis, the button 9 and 1 are used which are positioned in the same direction as the Y axis. That is, if the button 9 is depressed, the three-dimensional object is translated in the direction of the +Y axis, while, if the button 1 is depressed, the three-dimensional object is translated in the direction of the −Y axis.

In addition, to translate a three-dimensional object in the direction of the Z axis, the button 2 and 8 are used which are positioned in the same direction as the Y axis. That is, if the button 2 is depressed, the three-dimensional object is translated in the direction of the +Z axis, while, if the button 8 is depressed, the three-dimensional object is translated in the direction of the -Z axis.

Also, to translate a three-dimensional object in the direction of the HH axis, the button 6 and 4 are used which are positioned in the same direction as the HH axis. That is, if the button 6 is depressed, the three-dimensional object is translated in the direction of the +HH axis, while, if the button 4 is depressed, the three-dimensional object is translated in the direction of the −HH axis.

At this time, if the button corresponding to the direction of translation is depressed once for a short time period, the three-dimensional object is translated by the predetermined unit distance, on the other hand, if the button is depressed and held for more than a predetermined time, the three-dimensional object is translated continuously while the button is being depressed.

In addition, to translate a three-dimensional object in perspective toward the front side, the button 5 is used which is positioned in the same direction as the BH axis. That is, if the button 5 is depressed for a short time period, the three-dimensional object is translated forward by the unit distance to the direction of the user's eyes, while, if the button 5 is depressed for a short time period and subsequently depressed and held continuously for more than a predetermined time period, the three-dimensional object is translated forward continuously.

On the contrary, if the button 5 is depressed for more than a predetermined time period, the three-dimensional object is translated backward by the unit distance to the direction of the rear of the display screen, while, if the button 5 is depressed for more than a predetermined time period and held continuously, the three-dimensional object is translated backward continuously while the button is being depressed.

As described above, while a button-type device for three-dimensional rotation or translation control is explained referring to figures, it is not to be restricted by the embodiments and figures. Depressing and holding for a predetermined time period, or continuous depressing a button can change the roles each other for inputting. Various modifications and variations may occur to those skilled in the art, without departing from the scope and spirit of the invention, as defined by the appended claims.

### INDUSTRIAL APPLICABILITY

A button-type device, configured as above, for three-dimensional rotation or translation control in accordance with the present invention has several effects as follows: The manipulation of buttons in a button-part of a 3×3 array becomes simple and convenient by providing combinations of buttons on the horizontal, vertical, and diagonal lines, which correspond to the direction of axis of rotation and the direction of rotation. The direction of rotation, the angle of rotation, and the center axis of rotation can be selected to rotate the three-dimensional object. The axis of translation can be selected, enabling the unit translation and the continuous translation of the three-dimensional object along the axis of translation. Type of device, to which an application program that controls the rotation and the translation of a three-dimensional object is applied, can be diversified

What is claimed is:

1. A button-type device for three-dimensional rotation or translation control, in which an application program runs to rotate and to translate a predetermined three-dimensional object on a display screen, the button-type device comprising:
a) a button-part including 9 buttons of a 3×3 array and having combinations of buttons on horizontal, vertical, and diagonal lines, corresponding to the direction of rotation or translation of a three-dimensional object on the three-dimensional axis of rotation or along the axis of translation; and
b) a microcomputer for recognizing the depressed combination of buttons, the order of the button depressed, and the key-depressing time and outputting a control signal so as to rotate or to translate a portion of or whole configuration of the three-dimensional object on the display screen.

2. A device according to claim 1, wherein the three-dimensional object is a cube box having a whole configuration of a cube.

3. A device according to claim 2, wherein the axes of the three-dimensional object comprise:
a) an X axis, a Y axis, and a Z axis;
b) a HH axis which exists on a same plane of the X and the Y axis at an angle of 45 degrees from the −X and the Y axis; and
c) 4 diagonal axes which link a vertex of each regular square, which composes a unit surface of a solid cube, to a vertex of an opposite side by way of a center of mass.

4. A device according to claim 3, further comprising a memory which stores a unit angle of rotation of the predetermined three-dimensional object.

5. A device according to claim 4, wherein the microcomputer determines the direction of rotation of the three-dimensional object, either clockwise rotation or counterclockwise rotation, according to the order of buttons depressed by means of the button-part, and the angle of rotation according to the unit angle of rotation stored in the memory.

6. A device according to claim 4, wherein the microcomputer, when a predetermined button is depressed, generates a control signal to switch an operation mode from a rotation mode in which a three-dimensional object is rotated on each axis to a translation mode in which the three-dimensional object is translated in the (+) or (−) direction of each axis, or vice versa.

7. A device according to claim 6, wherein the microcomputer, according to the depression of the predetermined button, generates a control signal to change the axis on which the three-dimensional object is rotated or translated.

8. A device according to claim 7, wherein the microcomputer, according to the time of the depression of the predetermined button, generates a control signal for unit translation or continuous translation.

9. A device according to claim 8, wherein the microcomputer generates a control signal to translate the three-dimensional object along the +X axis when the buttons on a diagonal of the left-bottom direction, which corresponds to the direction of the X axis, are depressed from the button-part of a 3×3 array, and to translate the three-dimensional object along the −X axis when the buttons on a diagonal of the right-top direction are depressed.

10. A device according to claim 8, wherein the microcomputer generates a control signal to translate the three-dimensional object along the +Y axis when the buttons on a diagonal of the right-bottom direction, which corresponds to the direction of the Y axis, are depressed from the button-part of a 3×3 array, and to translate the three-dimensional object along the −Y axis when the buttons on a diagonal of the left-top direction are depressed.

11. A device according to claim 8, wherein the microcomputer generates a control signal to translate the three-dimensional object along the +Z axis when the buttons on a vertical line of upward direction, which corresponds to the direction of the Z axis, are depressed from the button-part of a 3×3 array, and to translate the three-dimensional object along the −Z axis when the buttons on a vertical line of downward direction are depressed.

12. A device according to claim 8, wherein the microcomputer generates a control signal to translate the three-dimensional object along the +HH axis when the buttons on a horizontal line of the right direction, which corresponds to the direction of the HH axis, are depressed from the button-part of a 3×3 array, and to translate the three-dimensional object along the −HH axis when the buttons on a horizontal line of the left direction are depressed.

13. A device according to claim 8, wherein the microcomputer generates a control signal to translate the three-dimensional object forward to the front or backward according to the time and the frequency of the depression of the button which is at the position of the second column of the second row from the button-part of a 3×3 array.

14. A device according to claim 7, wherein the microcomputer generates a control signal to rotate the three-dimensional object in the direction of counterclockwise on the X axis when the two different buttons on a diagonal, which proceeds to the left-top from the right-bottom, are depressed sequentially from the button-part of a 3×3 array, and
to rotate the three-dimensional object in the direction of clockwise on the X axis when the two different buttons on the diagonal are depressed sequentially from the left-top to the right-bottom.

15. A device according to claim 7, wherein the microcomputer generates a control signal to rotate the three-dimensional object in the direction of counterclockwise on the Y axis when the two different buttons on a diagonal, which proceeds to the left-bottom from the right-top, are depressed sequentially from the button-part of a 3×3 array, and
to rotate the three-dimensional object in the direction of clockwise on the Y axis when the two different buttons on the diagonal are depressed sequentially from the left-bottom to the right-top.

16. A device according to claim 7, wherein the microcomputer generates a control signal to rotate the three-dimensional object in the direction of counterclockwise on the Z axis when two different buttons on a horizontal line are depressed sequentially from the left to the right from the button-part of a 3×3 array, and
to rotate the three-dimensional object in the direction of clockwise on the Z axis when the two different buttons on the horizontal line are depressed sequentially from the right to the left.

17. A device according to claim 7, wherein the microcomputer generates a control signal to rotate the three-dimensional object in the direction of counterclockwise on the HH axis when two different buttons on a vertical line are depressed sequentially from the top to the bottom from the button-part of a 3×3 array, and
to rotate the three-dimensional object in the direction of clockwise on the HH axis when the two different buttons on the horizontal line are depressed sequentially from the bottom to the top.

18. A device according to claim 7, wherein the microcomputer generates a control signal to rotate the three-dimensional object in the direction of counterclockwise on the first diagonal axis when the button at the position of the first column of the first row is depressed twice or the button at the third column of the third row is depressed and held for more than a predetermined time from the button-part of a 3×3 array, and
to rotate the three-dimensional object in the direction of clockwise on the first diagonal axis when the button at the first column of the first row is depressed and held for a predetermined time period or the button at the third column of the third row is depressed repeatedly.

19. A device according to claim 7, wherein the microcomputer generates a control signal to rotate the three-dimensional object in the direction of counterclockwise on the second diagonal axis when the button at the position of the third column of the first row is depressed repeatedly or the button at the first column of the third row is depressed for more than a predetermined time period from the button-part of a 3×3 array, and
to rotate the three-dimensional object in the direction of clockwise on the second diagonal axis when the button at the third column of the first row is depressed and held for a predetermined time period or the button at the first column of the third row is depressed repeatedly.

20. A device according to claim 7, wherein the microcomputer generates a control signal to rotate the three-dimensional object in the direction of counterclockwise on the third diagonal axis when the button which is at the position of the second column of the first row is depressed repeatedly or the button at the second column of the third row is depressed for more than a predetermined time from the button-part of a 3×3 array, and
to rotate the three-dimensional object in the direction of clockwise on the third diagonal axis when the button at the second column of the first row is depressed and held for a predetermined time period or the button at the second column of the third row is depressed repeatedly.

21. A device according to claim 7, wherein the microcomputer generates a control signal to rotate the three-dimensional object in the direction of counterclockwise on the forth diagonal axis when the button which is at the position of the second column of the second row, the center, is depressed repeatedly from the button-part of a 3×3 array, and
to rotate the three-dimensional object in the direction of clockwise on the forth diagonal axis when the button at the second column of the second row is depressed for more than a predetermined time period.
